(19) United States
(12) Patent Application Publication
(10) Pub. No.: US 2007/0078955 A1
(43) Pub. Date: Apr. 5, 2007

(54) Service quality management in packet networks

(75) Inventors: John Siliquini, Menora (AU); Guven Mercankosk, Como (AU); Tarith Devadason, Mosman Park (AU); Steven Ivandich, Fremantle (AU); Kent Gibson, Noranda (AU); Justin Smith, Mt. Pleasant (AU)

Correspondence Address: ECKERT SEAMANS CHERIN & MELLOTT, 600 GRANT STREET, 44TH FLOOR, PITTSBURGH, PA, 15219, US

(73) Assignee: Xelor Software PTY LTD, Nedlands (AU)

(21) Appl. No.: 11/227,927

(22) Filed: Sep. 15, 2005

(51) Int. Cl. G06F 15/177

(52) U.S. Cl. 709/220

(57) ABSTRACT

A method of managing traffic flows in a network without human intervention which comprises detecting the establishment of at least one of a session and a traffic flow between endpoints, assigning a classification to at least one of the session and the traffic flow, and configuring a number of network devices to provide a certain level of service associated with the classification. Another aspect of the disclosure relates to a service quality management system for a network which comprises a service client structured to detect at least one of a session and a traffic flow established on the network and to produce a classification request for the at least one of the session and the traffic flow, and a service quality manager structured to configure one or more network devices to provide a certain level of service associated with the classification request.

### BACKGROUND

1 . Field

The invention relates generally to packet networks and, more particularly, to the management of traffic flows within packet networks.

2 Background Information

In many packet networks, such as Internet Protocol (IP) networks, all application classes typically receive a single level of service, such as best effort (BE) service. Thus, traffic flows originating from one class of application will receive the same level of service as traffic flows originating from another class of application. As a result, all applications may experience completely random latencies or varying throughput.

Certain application classes, however, may be more critical than others. Traffic flows originating from these critical application classes require a higher level of service than traffic flows originating from other application classes. For example, traffic flows originating from a real-time application (such as video streaming, voice over IP (VoIP), etc.) may be more critical than traffic flows originating from a data application (such as email, web downloads, file transfer applications, etc.). Thus, a higher level of service should be assigned to the traffic flows originating from the real-time applications than is assigned to the traffic flows originating from the data applications. Furthermore, traffic flows originating from a certain data application, such as data traffics flow from customer relationship management (CRM) software, may be more critical than traffic flows originating from certain other data applications, such as an email application. Thus, a higher level of service should be assigned to the traffic flows from the CRM application than is assigned to the traffic flows from the email application.

Additionally, certain quality of service (QoS) measures may be more crucial for traffic flows originating from certain application classes. Therefore, it is necessary to differentiate between the levels of service offered to the various traffic flows in relation to these QoS measures. For example, it may be desirable that a data packet within a traffic flow from a real-time VoIP application never experience delays greater than a certain threshold. In order to satisfy this desire, the VoIP traffic flow may require a level of service having a higher priority than, for instance, a traffic flow originating from a data application (e.g., an email application). As another example, a particular class of data traffic flow (e.g., data traffic flow from CRM software) may be very important to a business. It may be desirable to ensure that this particular class of data traffic flow experiences a certain minimum throughput when required, that it experiences minimal delays, and/or that it experiences minimal packet losses. Accordingly, this particular class of data traffic flow may require a level of service having a higher priority than other classes of data traffic flow.

The exact level of service received by each application class is subject to the policy implementations, such as the choice of a scheduling algorithm, used in the network nodes. The level of service also depends on the quantity of various resources (e.g., bandwidth, buffer memory, etc.) that is available and the amount of traffic in the relevant class that is present on the network.

Accordingly, a need exists for an improved method and/or apparatus for managing the traffic flows generated by disparate application classes on a network.

### SUMMARY

One aspect of the disclosure relates to a method of managing traffic flows in a network without human intervention. The method comprises detecting the establishment of at least one of a session and a traffic flow between endpoints, assigning a classification to at least one of the session and the traffic flow, and configuring a number of network devices to provide a certain level of service associated with the classification to the at least one of the session and the traffic flow.

Another aspect of the disclosure relates to a service quality management system for a network which comprises a service client structured to detect at least one of a session and a traffic flow established on the network and to produce a classification request for the at least one of the session and the traffic flow, the traffic flow including a plurality of data packets, and a service quality manager structured to configure one or more network devices to provide a certain level of service associated with the classification request for the at least one of the session and the traffic flow.

Another aspect of the disclosure relates to a network comprising a user device, an access device operable to connect the user device to the network, an application server, and a service quality management system structured to detect the establishment of at least one of a session and a traffic flow between the user device and the application server, assign a classification to at least one of the session and the traffic flow, and configure a number of network devices to provide a certain level of service associated with the classification to the at least one of the session and the traffic flow.

### BRIEF DESCRIPTION OF THE DRAWINGS

A full understanding of the invention can be gained from the following Description of the Preferred Embodiments when read in conjunction with the accompanying drawings in which:

FIG. 1 is a simplified block diagram illustrating a computer network for managing and supporting the delivery of distinct levels of service to disparate classes of applications.

FIG. 2 illustrates one example of the architecture of the computer network of FIG. 1.

FIG. 3 is a flow chart illustrating an operational process for establishing and maintaining a database relating to the topology and data classifications of the network of FIG. 1.

FIG. 4 is a flow chart illustrating an operational process for implementing the SQM function of the network of FIG. 1.

Similar numerals refer to similar parts throughout the specification.

### DESCRIPTION OF THE PREFERRED EMBODIMENTS

As briefly discussed above, certain network applications may require different levels of service. Some applications may be relegated to the lowest level of service, gaining access to residual network resources only when the other classes of applications have received their intended level of service. For example, data applications such as email, web downloads, and file transfer applications may be classified to receive the lowest level of service (such as the best effort (BE) level of service).

Other applications may more appropriately receive a level of service better than the BE level of service, and may be classified to receive, for example, an Assured Forwarding (AF) level of service. Such applications may require, for instance, client-server interaction and/or timely delivery of data crucial to business objectives. Examples of data applications that may be classified as receiving the AF level of service may include: remote desktop applications, enterprise resource planning (ERP) applications, customer relationship management (CRM) applications; sales force automation applications, enterprise Instant Messaging applications, control system applications (e.g., remote activation and control of industrial plant machinery applications), and data collection applications (e.g., telemetry collection).

Still other applications may more appropriately receive an even higher level of service, such as, an Expedited Forwarding (EF) level of service. For example, real-time applications requiring strict prioritization, as well as various forms of flow conditioning, may be classified as receiving the EF level of service. Examples of data applications that may be classified as receiving the EF level of service include: voice over IP (VoIP) applications, video conferencing applications, streaming video applications (such as video- or music-on-demand), interactive network gaming applications, and multi-media solution applications (e.g., applications which support the real-time sharing of a variety of applications).

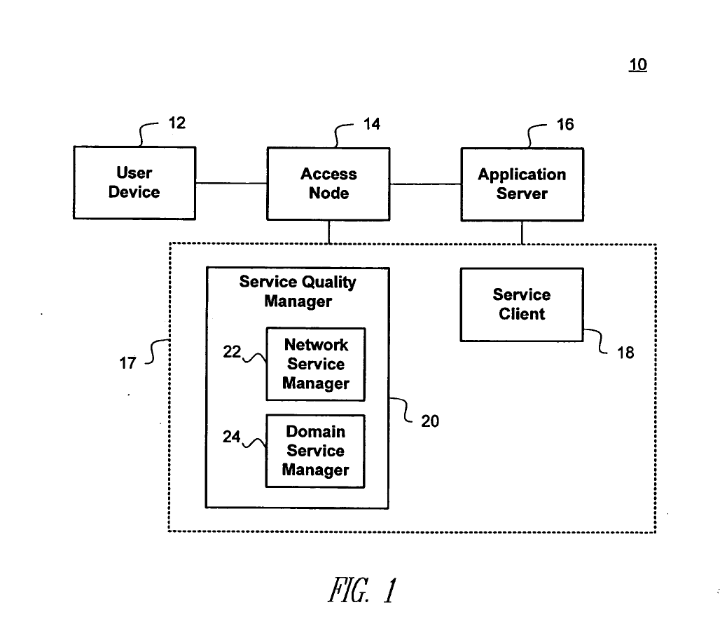

FIG. 1 is a simplified block diagram illustrating a computer network 10 for automatically managing and supporting the delivery of distinct levels of service to disparate classes of applications during concurrent usage of the network. More specifically, the network 10 is comprised of a user device 12, an access node 14, an Application Server 16, and a Service Quality Management System 17.

User device 12 may include (without limitation) a number of personal computers, workstations, IP phones, and/or personal digital assistants, among others. For the purposes of this document, the expression “a number of” and variations thereof shall refer broadly to any quantity, including a quantity of one. Access node 14 may include, for example, a switch that connects one or more user devices 12 to the other components within the network 10. An Application Server 16 refers to a centralized storage and management program provided for individual applications. For example, a program for storing and managing an email application may be referred to as an Application Server 16. A number of Application Servers 16 may reside on a single hardware device (e.g., a server). The user devices 12, access nodes, 14, and application servers 16 may be collectively referred to as network devices. It should be noted that the term “network device” may include other hardware and software components (such as and without limitation, internal nodes (e.g., routers, distribution devices, core devices, etc)). The Service Quality Management System 17 controls, in real-time and without human intervention, the classification of various applications and the level of service provided to the traffic flows related to each of the various applications.

In the current embodiment, the Service Quality Management System 17 includes a Service Client (SC) 18 component and a Service Quality Manager (SQM) 20 component. The SQM 20 component includes a Network Service Manager 22 component and a Domain Service Manager 24 component.

For the purposes of this document, a “session” and variations thereof refer to the period of time in which one endpoint within the network interfaces with another endpoint within the network. For example, a period of time in which the user device 12 (e.g., a first endpoint) interfaces with the Application Server 16 (e.g., a second endpoint) may be referred to as a session (e.g., the time period beginning when a user accesses an application and ending when the user quits the application). During the session, traffic flows are created by and exchanged between endpoints, here the user device 12 and the Application Server 16. A “traffic flow” and all variations thereof refer to a sequence of data packets generated, during a session, by an endpoint at a single address (at any Layer), destined for endpoint at another single address. For example for a user accessing an email application, data packets generated by the user device 12 and sent to the Application Server 16 during the session may be referred to as a traffic flow. Likewise, data packets generated by the Application Server 16 and sent to the user device 12 during the session may also be referred to as a traffic flow.

In the current embodiment, the SC 18 monitors the Application Server 16, detects a relevant session or traffic flow, and gathers information about the session or traffic flow. The information may be gathered from one or more signaling packets or by some other method. The SC 18 then sends this information, along with a service quality setup request, to the SQM 20. A “service quality setup request” refers to a request to classify an individual session or traffic flow so that the session of traffic flow receives a particular level of service. For example, the session may involve a CRM application critical to the user's business. As a result, the service quality setup request may ask that, during this session, this application receive a level of service higher than the BE level of service.

The SQM 20 receives the service quality setup request and establishes the appropriate classification for the session or traffic flow. If the request is granted, the session or traffic flow will receive the requested level of service. If the request is denied, the SQM 20 determines an appropriate classification for the session or traffic flow. After granting or denying the service quality setup request, the SQM 20 configures the access node 14 (and other network devices) appropriately to deliver the required level of service that is to be provided to the session or traffic flow traffic. Accordingly, any subsequent data packets within the session or traffic flow receive this level of service.

As seen in FIG. 1, the SQM 20 includes a Network Service Manager (NSM) 22 and a Domain Service Manager (DSM) 24. Generally, the NSM 22 receives the service quality setup request from the SC 18, establishes the appropriate classification for the session or traffic flow, and notifies the DSM 24 of the classification established for the session or traffic flow. The DSM 24 then instructs the access node 14 (and other network devices) to change settings accordingly so as to deliver the appropriate level of service established by the NSM 22 for traffic flows related to that session or traffic flow.

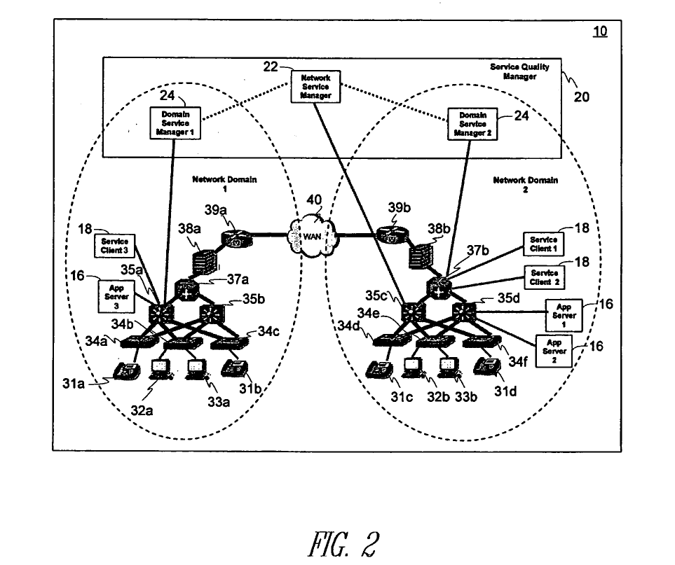

FIG. 2 illustrates a more detailed example of the architecture of the computer network 10 of FIG. 1. The network 10 includes several user devices 12, such as IP phones 31a -31d, personal computers 32a-32b, and personal digital assistants 33a-33b. The user devices 12 are connected with the other components of the network 10 via access nodes 14, such as switches 34a-34f. Each access node 14 may include one or more ports for connecting the user devices 12 with the other components of the network 10. Switch 34b, for example, has ports for connecting personal computer 32a and PDA 34a.

The access nodes 14 are in turn connected with servers 35a-35d, on which may reside one or more Application Servers 16a-16d. The servers 35a-35d are connected with core devices 37a- 37b(e.g., a IP-PBX Server). The core devices 37a-37b are connected to firewalls 38a-38b which prevent unauthorized access to or from the one or more portions of the network 10. The firewalls 38a-38b are in turn connected with a Wide Area Network (WAN) 40 via routers 39a-39b.

The network 10 may be logically partitioned into sections, referred to in FIG. 2 as network domain-1 and network domain-2. Each network domain is comprised of one or more routing domains or subnets or virtual local area networks (VLAN). For example, two sites of a distributed enterprise network interconnected by a wide area network virtual private network (WAN VPN) may be partitioned into two circuit domains (e.g., one for each site).

The network 10 also includes the Service Quality Management System 17, which as discussed above, controls in real-time and without human intervention the classification of traffic flows relating to various applications. In the current embodiment, the Service Quality Management System 17 is implemented in software and is logically divided into the SC 18 and the SQM 20.

The SC 18 and SQM 20 components can be collocated (e.g., on the same hardware device), or as illustrated in FIG. 2, distributed throughout the network 10. In the current embodiment, each Application Server 16a-16d has an SC 18 associated therewith. An SC 18 may be supplied as part of an original equipment manufacturer (OEM) package and distributed throughout the network 10 with its associated Application Server 16a-16d.

As discussed above, the SQM 20 functions may be partitioned, for scalability, into the NSM 22 functions and DSM 24 functions. Each network domain (i.e., network domain-1 and network domain-2) encompasses a set of network nodes (e.g., access nodes 14, internal nodes, etc.) which belong to the subnets contained within the network domain and which are controlled by a single DSM 24 (i.e., DSM1 for network domain-1 and DSM2 for network domain-2). Each DSM 24 is responsible for resource allocation and policy setup and release within its associated network domain and for any outgoing inter-DSM links.

As used herein, a “node” refers to a packet forwarding location within the network 10. The network 10 may include, without limitation, access nodes 14 and internal nodes (e.g., routers, distribution devices, core devices, etc.). A single device may function as more than one type of node, for example, a router may be both an access node and internal node.

The NSM 22 is aware of all routing domain links that interconnect network domains in the system, and co-ordinates the DSMs 24 controlling the network domains (i.e., network domain-1 and network domain-2). The NSM 22 may be collocated with a DSM 24 or may be hosted on a separate platform. Although, a minimal SQM 20 system contains a single NSM 22 and DSM 24, multiple NSMs 22 and DSMs 24 may exist in the network 10.

In the current embodiment, the Service Quality Management System 17 signals and authorizes the access node 14 carrying a traffic flow to appropriately mark the headers of the relevant data packets within the traffic flow. At some earlier stage, the Service Quality Management System 17 would have signaled all of the other nodes (e.g., internal nodes, access nodes 14, etc.) to appropriately configure them to provide each classification of data with its associated level of service.

Each SC 18 detects relevant application traffic in the network 10, for example, dynamically when a traffic flow is established and/or semi-permanently when the user logs onto the network 10. The SC 18 also gathers information about the relevant application traffic. Referring to FIG. 2 for example, assume that a user logs onto PC 32a and attempts to access a database application located on Application Server-3 via switch 34b. The SC 18 associated with Application Server-3 (i.e., SC-3) detects that the user has logged onto PC 32a and/or detects the traffic flow established between PC 32a and Application Server-3. Using an interface provided for the Application Server-3, SC-3 obtains information relating to the database traffic flow and identifies an appropriate classification for its packets.

The information gathered by SC-3 may generally include some or all of the following: the source Internet Protocol (IP) address or a reference to it (i.e., a registered application user or an Application Server); the destination IP address or a reference to it (i.e., a registered application user or an Application Server); the Transport Layer protocol (e.g. Transmission Control Protocol, TCP, or User Datagram Protocol, UDP); the source and destination Transport Layer (e.g. TCP or UDP) port numbers; the type of application traffic being sent on that flow (e.g. signaling or data); the minimum bandwidth requirements, if any; and the maximum acceptable delay or jitter, if applicable.

SC-3 then sends all or some of the gathered information, along with a service quality setup request, to the SQM 20 (e.g., using the SQM's API). The service quality setup request may include a request to have the specific traffic flow assigned a certain classification based, for example, on factors such as the importance of the type of data in the traffic flow, the QoS factors that crucially impact on that type of data, and any priority that the user involved (at the source or destination IP address) may enjoy. SC-3 may also advise the SQM 20 of the termination of the traffic flow by sending a service quality release request.

The SQM 20 accepts service quality requests from SC-3 and establishes resource and policy management functions within the network 10. The service quality actually assigned and applied to the traffic flow is controlled by the SQM 20.

The SQM 20 as a functional entity may perform several coordinating functions. The SQM 20 receives the information and service quality setup/release requests from an SC 18. The SQM 20 also authorizes or denies the classification requested by the service quality setup/release request. The SQM 20 may, for example, base this decision on a lookup table of applications, data types, and users (source or destination IP addresses) either provided to it or generated by some algorithm. If the SQM 20 denies the classification requested by the SC 18, the SQM 20 itself determines an appropriate classification for the session or traffic flow.

The SQM 20 then instructs the appropriate network device to mark each packet in the traffic flow. In the current example, for instance, the SQM 20 instructs switch 34b, through which PC 32a connects with the network 10, to mark each packet accordingly. In the event the switch 34b is not supported by the SQM 20, the SQM 20 may instructs an internal node to mark each packet in the traffic flow. For example, the SQM 20 may instruct the internal node that is closest to, and downstream of, the switch 34b. The specific method of marking each packet may vary while remaining within the scope of the present invention. The method chosen may be based on available standards at the time. For example, methods may be chosen to change currently available header fields including the Layer 2 VLAN header Class of Service (CoS), the Layer 3 IP header Differentiated Services (DiffServ) Code Point (DSCP), and/or a Multi-Protocol Label Switching (MPLS) label, among others.

The invention also envisages, for example, the use of up to four Assured Forwarding classes as specified in IETF RFC 2597, or equivalently VLAN CoS values 1-4 for application traffic requiring different levels of service. Data flows can also be marked for Best Effort (BE), to be part of a class that only receives the residual level of service available after all other classes have received their allocated entitlement.

The SQM 20 may also perform network topology and endpoint discovery. The SQM 20 may use, for example, the Simple Network Management Protocol (SNMP) Management Information Base (MIB) tables and/or Spanning Tree Protocol (STP) tables contained in network access nodes 14 for topology and endpoint discovery. Alternatively, topology and endpoint information may be imported from third party applications. The accuracy of the topology and endpoint information is maintained simultaneously with the other functions of the SQM 20. Thus, the topology and endpoint information is updated periodically to adjust for changing network conditions. In the current embodiment, discovery may be performed at Layer 2 and/or Layer 3, and includes both LAN and WAN components of the network 10.

The SQM 20 also maintains a profile for configuration of all network nodes to deliver specific levels of service to each individual class (i.e., the Service Profile). The level of service associated with each class, and the way in which network nodes will be configured to provide those levels, are left to particular implementations of the invention. Once established, this information is used by the SQM 20 to set up output trunk port configurations in all network nodes, including the choice of scheduling algorithms to be used (e.g. Weighted Round Robin, Weighted Fair Queueing, First Come First Served, etc.) and any weights or priorities to be assigned. These will define the Service Policy. Trusted boundaries on the trunk ports are also set, so that network 10 accepts the packet markings.

Determination of service levels and the appropriate way to configure trunk ports on the network nodes may be undertaken at the time topology discovery is performed. The SQM 20 signals all internal nodes in the network 10 to implement the chosen configuration on a semi-permanent basis (that is, until a change is made to the Service Profile).

Another function of the SQM 20 is to appropriately identify the packets from a traffic flow that have been given a particular classification, so that the packets will be served appropriately within the network 10. To ensure the intended level of service for each class, the traffic flows may first have to be qualified and conditioned before admission into the network 10.

To identify packets belonging to each class within the network 10, the SQM 20 signals the access node 14 for that source IP address to mark all packets from the identified traffic flow appropriately, based for example on the source and destination Layer 3 and Layer 4 addresses. In the network 10, all access nodes 14 are configured not to trust markings on incoming packets, so that only the SQM's 20 approved markings can pass into the network 10. These markings are employed by the network 10 to identify the appropriate way to deal with each packet, and may reside in any header field available for use in distinguishing classes of traffic. The Differentiated Services Code Point (DSCP) field in the IP header at Layer 3, or the Class of Service (CoS) field in the VLAN header at Layer 2, or both, are convenient repositories for these markings that can be exploited by most implementations of the invention. (A fixed mapping between DSCP and CoS field values would allow the relevant field to be used at Layers 3 and 2 respectively.)

The SQM 20 may also in some cases perform additional tasks to ensure service quality for certain types of traffic classes. It may for example be necessary to admit or reject traffic flows into the network 10, or into the requested class, based on the resources available for the requested class. This is referred to herein as admission control, and may be performed by the SQM 20 before signaling the access node 14 of admission or rejection. Admitted traffic flows may then need to be conditioned by the access nodes 14 to conform to certain criteria before injection into the network 10. For example, spacing or policing may be implemented at the access node 14 to manage network delays or bandwidths. The SQM 20 configures the access nodes 14 to perform these functions, where required, at the time of endpoint discovery or session detection as appropriate to the implementation. Prioritized expedited forwarding (EF) real-time traffic is one possible class for which admission control and policing may be employed to deliver the required level of service.

Depending on the type of class involved, the SQM 20 may remove the flow assignment, marking and conditioning configuration in the access node 14 when an application flow terminates.

This service quality management system 17 supports the complete automation of QoS management in an enterprise network by automatically classifying data application flows to be given different levels of service. The service quality management system 17 provides security by ensuring the network 10 retains complete control of packet markings at the access node's ports. Access node ports are not trusted, and applications do not control their class markings (i.e. DSCP or CoS typically). The service quality management system 17 also allows identification of flows at lower layers, e.g. Layer 2 or 3, and thus, is not affected by encryption. It avoids network management errors by use of consistent, automated network-wide control of configuration and policy enforcement; and any implementation of the service quality management system 17 can use widely available network hardware features. The service quality management system 17 avoids the need for QoS expertise to be available for network management, is scalable to networks of increasing size, and minimizes associated costs by being a software solution that does not require additional purchases of specialized hardware as the network grows.

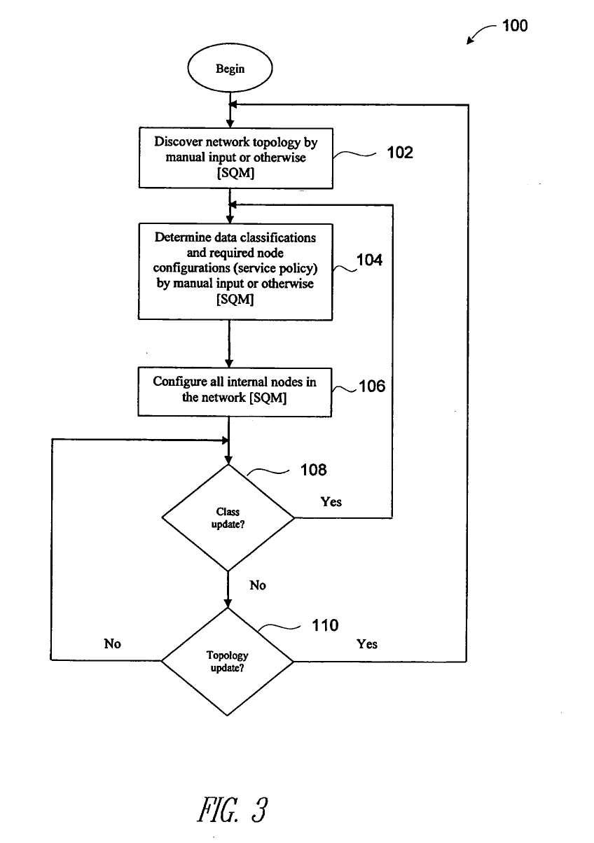

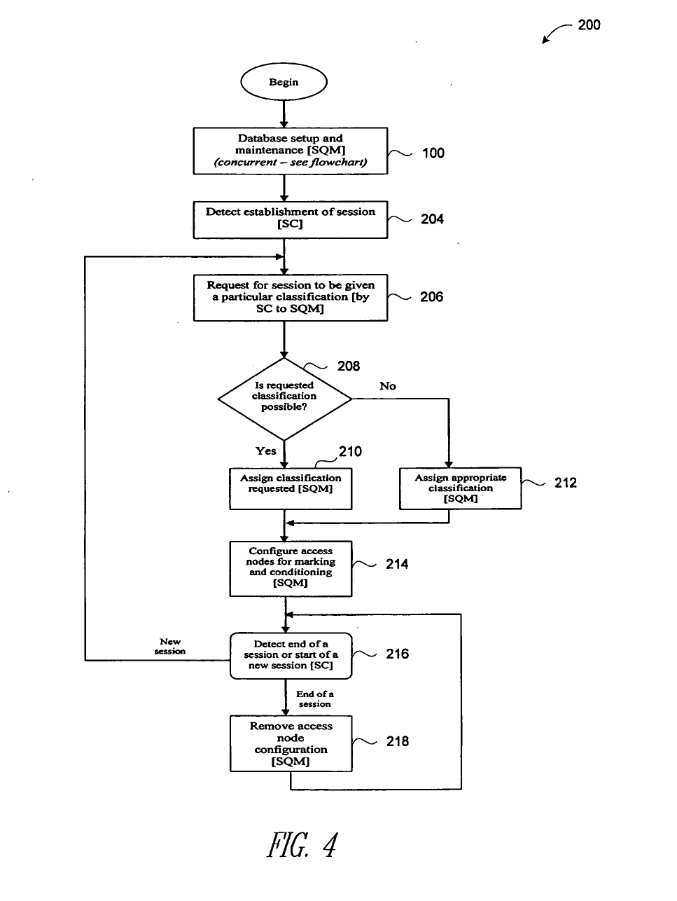

FIGS. 3 and 4 are flow charts illustrating operational processes for managing traffic flows within the network without human intervention. More specifically, FIG. 3 illustrates operational process 100 for establishing and maintaining a database relating to the topology and data classifications of the network 10. Referring to FIG. 3, operational process 100 is initiated as at operation 102 when the SQM 20 discovers the network topology. As discussed above, the SQM 20 may use, for example, the Simple Network Management Protocol (SNMP) Management Information Base (MIB) tables and/or Spanning Tree Protocol (STP) tables contained in network nodes for topology and endpoint discovery. Alternatively, topology and endpoint information may be imported from third party applications.

After the network topology is discovered, operational control is passed to operation 104. In operation 104, the SQM determines the data classifications and required node configurations (i.e., determines the service policy for the network 10). As discussed above, the SQM 20 maintains a profile for configuration of all network nodes to deliver specific levels of service to each individual class.

Operational control is then passed to operation 106 in which the SQM 20 configures all of the internal nodes within the network 10. The SQM 20 signals all internal nodes in the network 10 to implement the configuration chosen in operation 104. In the current embodiment, the internal nodes are configured on a semi-permanent basis (that is, until a change is made to the Service Profile).

After the internal nodes are configured in operation 106, a determination is made at operation 108 as to whether a class update is needed. If a class update is needed, operational control is returned to operation 104. If a class update is not needed, operational control branches “NO” and a determination is made at operation 110 as to whether a topology update is needed. If a topology update is needed (e.g., a device has been added/removed from the network 10), operational control is returned to operation 102. If a topology update is not needed, operational control branches “NO” and control is returned to operation 108. As seen in FIG. 3, operational process 100 continuously determines whether a class and/or topology update is needed, and if needed, implements the steps necessary to update the class and/or topology.

FIG. 4 illustrates the operational process 200 for implementing the SQM function for the network 10. Referring to FIG. 4, operational process 200 begins concurrently with operational process 100, which as discussed above in conjunction with FIG. 3, establishes and maintains the database relating to the topology and data classifications of the network 10. Operational control is then assumed by operation 204 which detects the establishment of a session. In the current embodiment, the establishment of a session is detected by an SC 18. The session may be detected by detecting a user log in, detecting data packets associated with a traffic flows that are exchanged between endpoints, or detecting information related to a traffic flow, among others.

After the establishment of a session is detected, a request for a particular classification for the session is generated at operation 106. In the current embodiment, the SC 18 generates and forwards a service quality setup request to the SQM 20.

A determination is then made at operation 208 as to whether the requested classification can be granted. If the requested classification is possible, operational control branches “YES” and the requested classification is assigned in operation 210. If the requested classification is not possible, operational control branches “NO” and an appropriate classification is assigned at operation 212. In the current embodiment, the SQM 20 determines whether the service quality setup request is grantable. If so, the SQM assigns the requested classification; if not, the SQM 20 determines and assigns the appropriate classification.

After a classification has been assigned at either operation 210 or 212, operational control passes to operation 214 and the access nodes 14 are configured to mark and condition the traffic flows generated in the session. In the current embodiment, the SQM 20 configures the access nodes 14, which then mark and condition the data packets with the traffic flows associated with the session.

After the access nodes are configured at operation 214, operation 216 detects the termination of a session and/or the establishment of a new session. If the termination of the session is detected, operational control passes to operation 218 and the configuration that completed in operation 214 is removed from the access nodes 14. In the current embodiment, if the SC 16 detects the termination of the session, the SQM 20 signals the access nodes 14 to remove the configuration. If the SC 16 detects the establishment of a new session, operational control returns to operation 206 and the SC 16 generates and forwards a service quality setup request to the SQM 20 (as discussed above).

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A method of managing traffic flows in a network without human intervention comprising:
detecting the establishment of at least one of a session and a traffic flow between endpoints;
assigning a classification to at least one of said session and said traffic flow; and
configuring a number of network devices to provide a certain level of service associated with said classification to the at least one of said session and said traffic flow.

2. The method of claim 1 wherein said detecting the establishment of at least one of a session and a traffic flow between endpoints comprises at least one of:
detecting a user log in;
detecting a number of data packets exchanged between said endpoints, each of said number of data packets being associated with said traffic flow; and
detecting information related to said each of at least some of said number of traffic flows.

3. The method according to claim 1 wherein said assigning a classification to at least one of said session and said traffic flow comprises:
collecting information related to at least one of a user log in, a number of data packets exchanged between said endpoints, and each of at least some of a number of traffic flows associated with said session;
producing a request based on said information for a certain classification for said at least one of said session and said traffic flow; and
responsive to said producing a request, assigning said classification to said at least one of said session and said traffic flow.

4. The method according to claim 1 wherein said configuring a number of network devices comprises establishing resource and policy management functions for said network.

5. The method according to claim 4 wherein said establishing resource and policy management functions for said network is responsive to at least one of the type of application being accessed during said session, the data type of a plurality of data packets within said traffic flow, a profile of a user initiating said session, and availability of network resources.

6. The method according to claim 4, wherein said establishing resource and policy management functions comprises:
determining a configuration profile for each of at least some of a number of internal nodes within said network; and
applying said configuration profile to said each of at least some of said number of internal nodes.

7. The method according to claim 1 further comprising:
determining a packet admission, marking, and conditioning configuration profile for said session;
applying said packet admission, marking, and conditioning configuration profile to at least one of an access node and an internal node; and
upon session termination, removing said packet admission, marking, and conditioning configuration profile from said at least one of an access node and an internal node.

8. The method according to claim 1 further comprising:
determining a topology of said network; and
determining said endpoints of said network.

9. A service quality management system for a network comprising:
a service client structured to detect at least one of a session and a traffic flow established on said network and to produce a classification request for the at least one of said session and said traffic flow, said traffic flow including a plurality of data packets; and
a service quality manager structured to configure one or more network devices to provide a certain level of service associated with said classification request for at least one of said session and said traffic flow.

10. The service quality management system of claim 9 wherein to detect at least one of a session and a traffic flow established on said network said service client is structured to at least one of:
detect a user log in;
detect a number of data packets exchanged between a number of endpoints; and
detect information related to said traffic flow.

11. The service quality management system of claim 9 wherein said service quality manager includes a network service manager and a domain service manager.

12. The service quality management system of claim 11 wherein said domain service manager is structured to allocate resources and to establish policy setup and release within a network domain.

13. The service quality management system of claim 11 wherein said network service manager is structured to store information relating to one or more routing domain links and to coordinate a number of domain service managers within said network.

14. The service quality management system of claim 9 wherein said network further comprises a number of user devices, a number of access nodes, a number of internal nodes, and a number of application servers, and wherein said session includes said plurality of data packets traveling between at least one of said user devices and at least one of said application servers.

15. The service quality management system of claim 14 wherein said service quality manager is structured to:
identify each of said plurality of data packets from at least one of a source address and a destination address associated with said at least one of said user devices and said at least one of said application servers;
instruct an access device associated with said at least one of said user devices to mark each of said plurality of data packets responsive to said classification request;
control admission of said plurality of data packets into said network; and
condition said plurality of data packets admitted into said network.

16. The service quality management system of claim wherein 15 wherein admission of said plurality of packets is responsive to the availability of network resources for said traffic flow.

17. A network, comprising:
a user device;
an access device operable to connect said user device to said network;
an application server; and
a service quality management system structured to:
detect the establishment of at least one of a session and a traffic flow between said user device and said application server;
assign a classification to at least one of said session and said traffic flow; and
configure a number of network devices to provide a certain level of service associated with said classification to the at least one of said session and said traffic flow.

18. The network according to claim 17 wherein said user device includes at least one of an IP phone, a personal digital assistant, a personal computer, and a workstation.

19. The network according to claim 17 wherein said access device includes a switch having an access port structured to connect said user device to said network.

20. The network according to claim 17 wherein said number of network devices includes at least one of a user device, a switch, a router, and an application server.

21. The network according to claim 17 wherein said application server is structured to provide data storage for and manage one or more applications.

22. The network according to claim 17 wherein said service quality management system includes a service quality manager and a service client.

23. The network according to claim 22 wherein said service quality manager includes a network service manager and a domain service manager.

24. The network according to claim 22 wherein, for said assign a classification to at least one of said session and said traffic flow, said service client is configured to:
collect information related to at least one of a user log in, a number of data packets exchanged between said user device and said application server, and each of at least some of a number of traffic flows associated with said session;
produce a request based on said information for a certain classification for said at least one of said session and said traffic flow.

25. The network according to claim 22 wherein, for said assign a classification to at least one of said session and said traffic flow, said service quality manager is structured to establish resource and policy management functions for said network responsive to a request for classification.
